(19) United States
(12) Patent Application Publication
(10) Pub. No.: US 2018/0258672 A1
(43) Pub. Date: Sep. 13, 2018

(54) AUTOMOTIVE DOOR HAVING INTERIOR DOOR HANDLE FOR PREVENTING ACCIDENT

(71) Applicant: Yun Jae Lee, Seoul (KR)

(72) Inventors: Yun Jae LEE, Seoul (KR); Go eun LEE, Seoul (KR); Si eun LEE, Seoul (KR)

(21) Appl. No.: 15/979,618

(22) Filed: May 15, 2018

(30) Foreign Application Priority Data
Nov. 18, 2016 (KR) 20-2016-0006742

(51) Int. Cl. E05B 85/12

(52) U.S. Cl. CPC E05B 85/12

(57) ABSTRACT

Provided is an automotive door having an interior door handle for preventing an accident. The door handle is connected to a rod to control operation of a door lock assembly inside a vehicle and is disposed on a door of the vehicle at a position corresponding to the shoulder of an adult sitting in the vehicle. Since the door handle is disposed on a door at a position corresponding to the shoulder of an adult sitting in the vehicle, when a passenger opens a door to exit a vehicle, his/her body is naturally turned back, so his/her eyes also naturally face the rear area. Accordingly, a collision with another vehicle, a motorcycle, or a bicycle approaching from behind can be prevented. Further, since the passenger looks back every time he/she opens a door, his/her consciousness about a safety accident when opening a door is increased.

### BACKGROUND OF THE INVENTION

### Field of the Invention

The present invention relates to an automotive door having an interior door handle of a door lock of a vehicle and, more particularly, an automotive interior door handle for preventing an accident when a door is opened with a vehicle stopped, the door handle being disposed on a door of a vehicle at a position corresponding to the shoulder of an adult sitting in the vehicle so that a passenger can safely exit the vehicle by opening a door after checking the rear area.

### Description of the Related Art

In general, automotive doors are designed to be opened and closed by users, that is, a user opens an automotive door by unlocking a door lock by pulling a door handle that is operated with the door lock.

However, since passengers usually open an automotive door without looking back to check whether there is another vehicle, a motorcycle, or a bicycle approaching from behind, a collision accident frequently occurs.

In order to solve this problem in the related art, as shown in FIG. 1, a method of attaching a mirror 9 inside a sun visor 8 has been proposed, but sun visors 8 that are attached to the upper edge of automotive doors are different in size and shape in accordance with models of vehicle, so it should be set forth as a premise to manufacture and use sun visors that are fit to vehicles in order to use this method in the related art. Further, there are drivers who do not want to use sun visors, but they have to submit to troublesome processes and costs for attaching unnecessary sun visors in order to use the sun visors as rear view mirrors.

Further, a lock that automatically locks an automotive door when a vehicle is driven at a predetermined speed or higher, a device that opens a door when a driver operates a lever at a side of a driver seat after checking the rear area when a passenger wants to get off a taxi, a sliding door that slides up or to a side, and a method of teaching people to open a door with a hand farther from the door, that is, the right hand for a left door and the left hand for a right door, as shown in FIG. 3, have been proposed to avoid a collision with a bicycle for example when opening a door.

However, even though such methods and devices have been proposed, passengers unconsciously do not look at a mirror when opening an automotive door in many cases. Further, the mirrors that are installed outside are unavoidably small in size, so the efficiency is low, and even if the mirrors are installed, they cause aerodynamic resistance while a vehicle is driven, so they have an adverse influence on the fuel efficiency.

Further, additional cost is required due to manufacturing and installing separate structures. Furthermore, the method of teaching people to open a door with a hand farther from the door is just a method of giving them warning, so it is difficult to physically control the habits of unconsciously opening an automotive door without checking the rear area or opening an automotive door with a hand closer to the door, for example, the left hand for the left door and the right hand for the right door for the structure of automotive doors.

### SUMMARY OF THE INVENTION

The present invention has been made in an effort to solve the problems and an object of the present invention is to provide an automotive interior door handle for preventing an accident when a door is opened with a vehicle stopped, the door handle being disposed on a door of a vehicle at a position corresponding to the shoulder of an adult sitting in the vehicle so that a passenger can safely exit the vehicle by opening a door after checking the rear area.

An automotive interior door handle for preventing an accident when a door is opened, in accordance with an aspect of the present invention, is connected to a rod to control operation of a door lock assembly inside a vehicle and is disposed on a door of the vehicle at a position corresponding to the shoulder of an adult sitting in the vehicle.

A door handle lever of a door handle on a right door and a door handle lever of a door handle on a left door are symmetrically arranged to correspond to a passenger sitting in a vehicle.

The door handle includes a top handle lever for opening a door when pulled by the rod and a spring and a bottom door handle fixed to the door under the top handle lever.

According to the present invention, since the door handle is disposed on a door at a position corresponding to the shoulder of an adult sitting in the vehicle so that a passenger opens the door by operating the door handle with a hand farther from the door to exit the vehicle.

Accordingly, when a passenger opens the door, his/her body is naturally turned back and his/her eyes also naturally face the rear area, so a collision with another vehicle, a motorcycle, or a bicycle approaching from behind can be prevented. Further, since the passenger has to look back, his/her consciousness about a safety accident when opening a door is increased.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a front view showing a rear view mirror for a passenger in the rear seat of a vehicle in the related art;

FIG. 2 is a view showing a door handle on a left door in the related art;

FIG. 3 is a view showing a case in which a passenger opens and closes a right door using a door handle in the related art;

FIG. 4 is a view showing a door handle on a left door according to an embodiment of the present invention;

FIG. 5 is a view showing a case in which a passenger opens and closes a right door using a door handle according to the embodiment of the present invention;

FIG. 6 is an enlarged view of the door handle of a right door according to the embodiment of the present invention; and

FIG. 7 is a view showing a door handle on a right door according to another embodiment of the present invention.

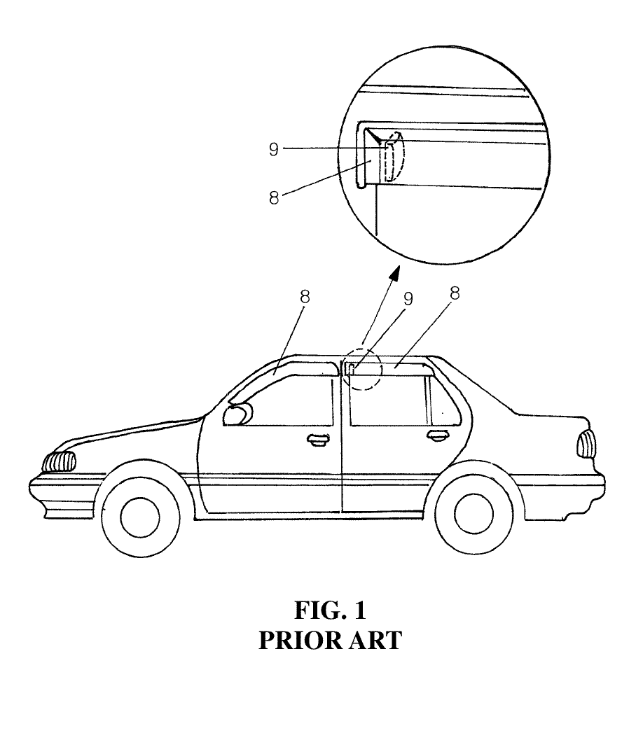

### DETAILED DESCRIPTION OF THE INVENTION

Exemplary embodiments of the present invention will be described with reference to the accompanying drawings to help sufficiently understand the present invention. Embodiments of the present invention may be modified in various ways and the scope of the present invention should not be construed as being limited to the embodiments to be described below.

When functions and configurations of components well known in the art may make the gist of the present invention unclear, a detailed description of the components will be omitted.

In the following description, door handles including door levers mounted on a left door and a right door of the related art and door handles including door levers mounted on a left door and a right door of the present invention are given the same reference numerals.

The present invention provides a door handle disposed in an automotive door lock to be able to control the operation of a door lock assembly inside a vehicle by being connected to a rod (not shown). The door handle 10 inside a vehicle, as shown in FIG. 5, is disposed at a position corresponding to the shoulder of a passenger sitting in a vehicle.

The door handle 10 may be a right door handle 10 including a door handle lever 11 and a left door handle 10 including a door handle lever 11.

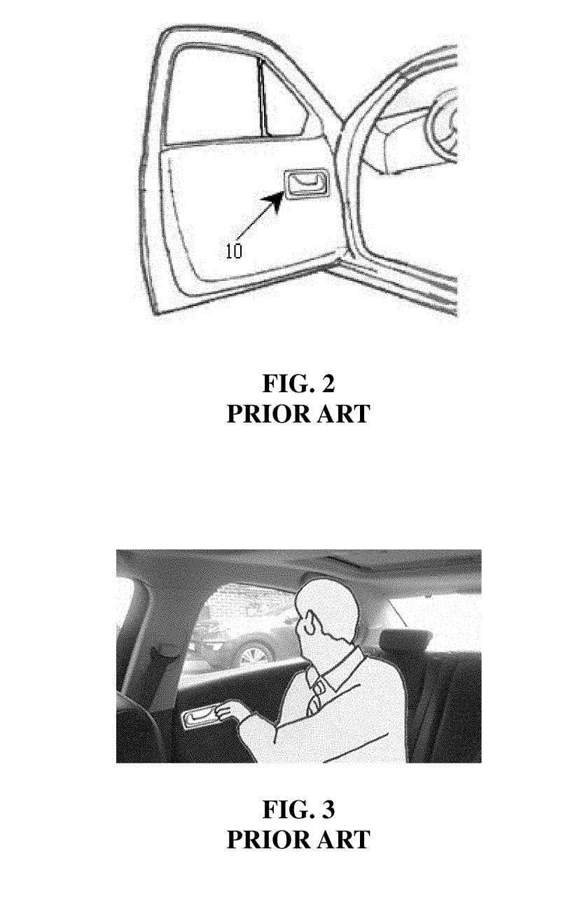

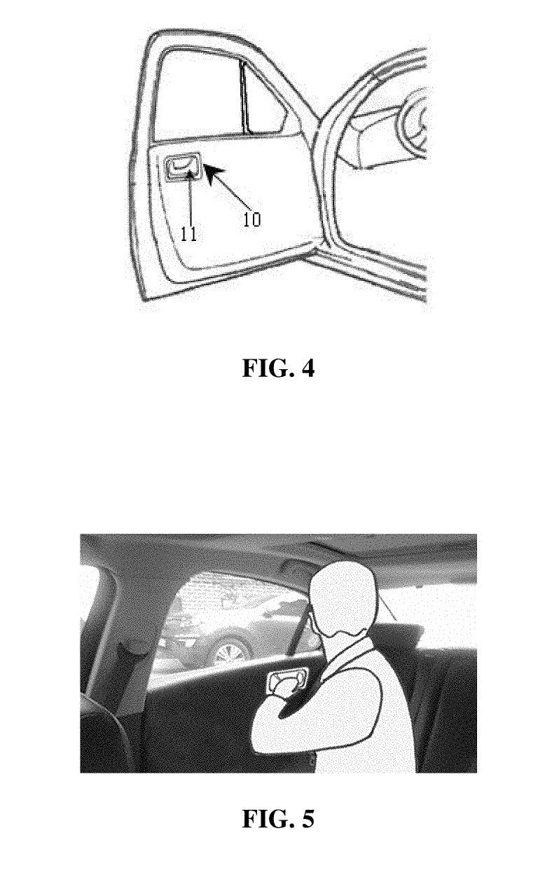

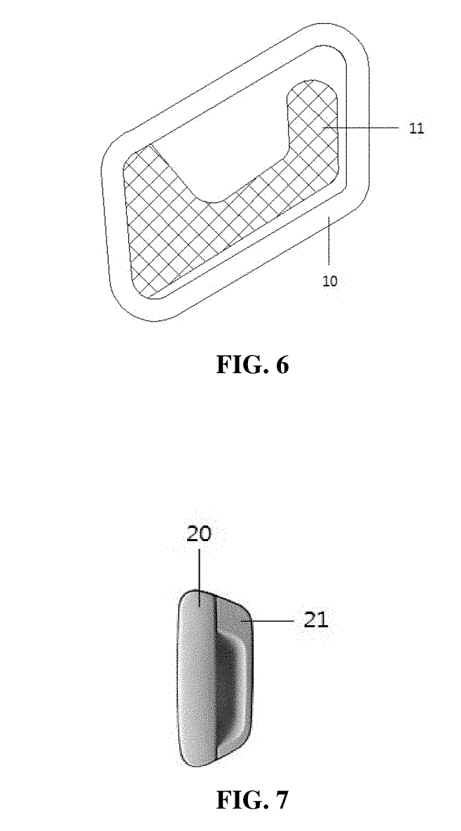

According to the present invention, in order that a passenger can easily pull the door handle lever 11 of the door handle 10 on a right door, as shown in FIGS. 5 and 6, and the door handle lever 11 of the door handle 10 on a left door, as shown in FIG. 4, while looking at the rear area at the sitting position, the door handle 10 on the right door and the door handle 10 on the left door are arranged respectively symmetrically to the door handle 10 on a left door shown in FIG. 2 and the door handle on a right door shown in FIG. 3.

The symmetric arrangement means that the door handle lever 11 of the door handle 10 on the right door shown in FIGS. 5 and 6 and the door handle lever 11 of the door handle 10 on the left door shown in FIG. 4 are arranged respectively symmetrically to the door handle lever of the door handle 10 on the left door shown in FIG. 2 and the door handle lever on the door handle 10 on the right door shown in FIG. 3.

Accordingly, when a passenger opens a door to exit a vehicle, his/her body is naturally turned back, so his/her eyes also naturally face the rear area. Further, since the door handle levers 11 of the door handles 10 respectively on the left door and the right door are arranged symmetrically to the door handle levers 11 of the related art, the passenger can easily open the left door or the right door by pulling the door handle levers 11 symmetrically arranged, as described above.

FIG. 2 shows a door handle 10 on a left door in the related art and FIG. 3 shows a case in which a passenger opens/closes a right door using a door handle 10 on the right door. As shown in FIG. 3, since the door handle 10 is positioned ahead relative to the present invention, when a passenger opens the door, he/she has difficulty in checking the rear area unless he/she consciously looks back. Accordingly, collisions with a vehicle, for example, a bicycle approaching from the rear area, frequently occur.

In order to prevent this accident when a passenger opens a door, the door handle 10 on a left door, as shown in FIG. 4, and the door handle 10 on a right door, as shown in FIG. 5, are positioned relatively rearward, as compared with the related art, so a passenger naturally turns his/her body and looks the rear area even though he/she does not consciously turn and look back. In other words, the position of the door handle 10 of the present invention is located at an inner rear end portion of each of the left and right doors, which is located higher and rearer than the position of the conventional door handle, such that it is arranged at a position corresponding to a passenger's shoulder when he or she sits in a rear seat for the passenger to turn back and notice the rear traffic environment of the car to see whether a vehicle is passing by the car stopped or not. Accordingly, the passenger can open the doors after checking whether a vehicle and a bicycle are approaching from the rear area.

As another embodiment of the interior door handle 10, the door handle can include, as shown in FIG. 7 exemplifying a right door, a top handle lever 20 that opens a door when pulled by a passenger by a rod (not shown) and a spring (not shown) and a bottom door handle 21 fixed to the door under the top handle lever 20, so a passenger inside a vehicle can easily open/close the door.

The door handle 10 having this configuration to prevent an accident when a door is opened is positioned on the door to correspond to the shoulder of an adult when he normally sits on the seat, so a passenger turns his/her body back and naturally looks back when opening the door to exit a vehicle. Accordingly, a collision with another vehicle, a motorcycle, or a bicycle approaching from behind the car can be prevented. Further, since the passenger looks back every time he/she opens a door, his/her consciousness about a safety accident when opening a door is increased.

Further, since the door handle 10 is positioned relatively at the rear portion of a door, as compared with the related art, the rod connecting the door handle 10 and a door lock assembly which is position to the rear end of the door is shortened, as compared with the related art, so the material is reduced and the manufacturing cost is also decreased.

It would be understood by those skilled in the art that the present invention may be modified with departing from the scope of the present invention. The embodiments stated herein are provided only for describing the present invention, not limiting the present invention. Accordingly, those skilled in the art would understand that various and equivalent modifications can be achieved from the embodiments. Therefore, the technical protective region of the present invention should be determined by the scope described in claims.

What is claimed is:

1. An automotive door, comprising an interior door handle for preventing an accident,
wherein the interior door handle incudes a handle lever configured to be connected to a rod located inside the automotive door to control operation of a door lock assembly inside a vehicle, and
wherein the door handle is located at a rear end portion of the door, such that a position of the door handle can be adjacent to a shoulder of an adult sitting in the vehicle.

2. The door handle of claim 1, wherein the handle lever is a top handle lever for opening the automotive door when pulled by the rod, and wherein the interior door handle includes a bottom door handle fixed to the automotive door and arranged below the top handle lever.
